(19) United States
(12) Patent Application Publication
(10) Pub. No.: US 2016/0161919 A1
(43) Pub. Date: Jun. 9, 2016

(54) TIME INDICATING DEVICES BASED ON COUNTERBALANCING REACTIONS

(71) Applicant: JP LABORATORIES, INC., Middlesex, NJ (US)

(72) Inventors: Gordhanbhai Patel, Somerset, NJ (US); Julia Koleda, Linden, NJ (US)

(21) Appl. No.: 14/907,282

(22) PCT Filed: Jun. 27, 2014
(86) PCT No.: PCT/US14/44577

§ 371 Date: Jan. 23, 2016

Related U.S. Application Data
(60) Provisional application No. 61/840,551, filed on Jun. 28, 2013.

(51) Int. Cl. G04F 1/00; G01N 21/25; G01N 31/22

(52) U.S. Cl. CPC G04F 1/00; G01N 31/229; G01N 21/25

(57) ABSTRACT

Indicating devices based on the counter balancing effect of one parameter with that of others are disclosed. Color changing and self-reading indicating devices, such as a time indicator having essentially no effect of temperature are developed by this method. In diffusion based time-temperature indicating devices, the effect of temperature is lowered by crosslinking the medium of the device. The devices have net activation energy near zero kcal/mole.

This application claims the benefit of U.S. Provisional Application No. 61/840,551, filed Jun. 28, 2013.

The present invention relates to indicating devices and processes wherein an effect of one parameter is controlled by counter balancing it with that of another. Specifically, it relates to color changing and self-reading time indicating devices having essentially no effect of temperature.

### BACKGROUND OF INVENTION

Whenever a clock or timer is impractical or too expensive to use, color changing time indicators or indicating devices in forms of labels, stickers or badges can be used.

Indicators for monitoring the passage of time are referred herein to as time indicators or time indicating devices (TI) including, but not limited to, visual validation of time, safety sticker, self-timing retail sticker, biological industrial process monitoring, self-expiring stickers to prevent re-use, employee ID and security ID labels, visitors badges, self-expiring parking tags, package and shipping labels, wrist bands, time indicating tickets for trains, buses, sport events, theaters etc., self-expiring passes for tours, emergency rooms, hospitals, museums, and other locations, event passes, security labels for screened luggage, purses, bags at airports to show the aircraft control people that the particular items were inspected, unmanned but video controlled entrances for visitors where the self-expiring visitor label issued electronically. So called color changing time indicators available in the market and even reported in the literature always have effect of temperature and they are strictly time-temperature indicators rather than “time only” indicators. Hence, there is a need for a color changing or self-reading time indicator with little or no effect of temperature.

The Arrhenius equation gives the quantitative basis of the relationship between the activation energy and the rate at which a reaction proceeds. From the Arrhenius equation, the activation energy (Ea) can be expressed as:

K=Ae^{-Ea/RT}

where A is the frequency factor or often call Arrhenius factor for the reaction, R is the universal gas constant, T is the temperature (in Kelvins), and k is the reaction rate coefficient.

In order to use a device as a time indicator, its activation energy should be very low, e.g., below 15 kcal/mole, preferably below 5 kcal/mole, further preferably zero kcal/mole. However, there may be barely a few such reactions in the literature with Ea of less than 5 kcal/mole. Even if such reactions exist, it will be difficult to prepare small and simple sticker or label type devices based on such reactions. Typically, as the temperature increases the rate of reaction increases and vice versa. For most of the reactions, the rate of reaction doubles (Ea=˜20-25 kcal/mole) with every 10° C. increase in temperature and vice versa. Hence, it is essentially impossible to prepare a true time indicating device.

A number of indicating devices, such as time, time-temperature, food doneness, freeze, thaw, humidity and sterilization indicators are known and a large number of patents have been issued on these devices. However, there is no report on converting one device into the other, e.g., time-temperature indicator into a time indicator or indicating devices based on counter balancing effect of one parameter with that of another.

### BRIEF SUMMARY OF THE INVENTION

The current invention relates to process of developing indicating devices based on counter balancing effect of one parameter with that of another parameter of the device and to the devices that are obtained by the process.

In one example, the process comprises choosing combinations of activators and barriers for the devices so that competing reactions are possible. While the concept of varying or minimizing the effect of temperature by crosslinking a medium or the barrier layer is described more fully below, the processes that can be used to minimize or vary the effect of temperature can be varied include other reactions/processes, such as degradation, polymerization, crosslinking, depolymerization, decomposition, conversion, complexation, halogenation, dehydrohalogenation, precipitation, catalytic reaction, synthesis, displacement, acid-base, oxidation-reduction, neutralization, condensation, isomerization, hydrolysis, addition, elimination, substitution, rearrangement, adsorption-desorption, exchange, redox, gelling, swelling, change in viscosity or hardness, density/specific gravity and solubility. These are some of the processes that can be used for varying the effect of temperature or controlling the rate of the reaction and the activation energy. Basically, any process or material which can counter the effect of temperature can be used to make the time indicating devices with little or no effect of temperature.

One embodiment of the invention relates to an indicating device wherein the effect of one parameter is substantially counter balanced by an effect of another parameter of the device.

Another embodiment relates to an indicating device wherein the effect of temperature is substantially counter balanced either by a process taking place within the indicating device or a material within the indicating device.

Another embodiment relates to an indicating device wherein the effect of temperature is substantially counter balanced by a process composed of one or more of degradation, polymerization, crosslinking, depolymerization, decomposition, conversion, complexation, halogenation, dehydrohalogenation, precipitation, catalytic reaction, synthesis, displacement, acid-base, oxidation-reduction, neutralization, condensation, isomerization, hydrolysis, addition, elimination, substitution, rearrangement, adsorption-desorption, exchange, redox, gelling, swelling, change in viscosity or hardness, density/specific gravity and solubility.

Yet another embodiment of the invention relates to an indicating device wherein the effect of temperature is substantially counter balanced by a process of crosslinking of a medium/binder material of the device.

Another embodiment relates to an indicating device wherein an increase in the rate of diffusion due to increase in temperature is substantially counter balanced by the crosslinking of a medium/binder material of the device.

Another embodiment of the invention relates to an indicating device wherein the increase in rate of diffusion due to increase in temperature is substantially counter balanced by crosslinking a barrier layer with a crosslinking agent.

Another embodiment relates to an indicating device wherein the crosslinking agent is a polymerizable monomer and multivalent cation.

Another embodiment relates to an indicating device which is a time indicating device having substantially no effect of temperature.

Another embodiment of the invention relates to a time indicating device having an overall activation energy below 10 kcal/mole.

Another embodiment relates to a time indicating device having an overall activation energy of near zero kcal/mole.

Yet another embodiment relates to a time indicating device which is color changing or self-reading.

Another embodiment relates to a time indicating device used as visual validation of time, safety sticker, self-timing retail sticker, biological industrial process monitoring, self-expiring stickers to prevent re-use, employee ID and security ID labels, visitors badges, self-expiring parking tags, package and shipping labels, wrist bands, time indicating tickets for trains, buses, sport events, theaters etc, self-expiring passes for tours, emergency rooms, hospitals, museums, and other locations, event passes, security labels for screened luggage, purses, bags at airports to show the aircraft control people that the particular items were inspected, unmanned but video controlled entrances for visitors where the self-expiring visitor label is issued electronically.

Yet another embodiment relates to a time indicating device comprising an activator which is capable of crosslinking a medium of the device.

Another embodiment relates to a time indicating device comprising an activator which is capable of crosslinking a barrier layer the device.

Another embodiment relates to a time-indicating device wherein the service life or shelf life of the system is varied or adjusted by changing one or more of the parameters selected from the group of: nature and thickness of activator, indicator and barrier layers and nature and quantity of activator, indicators and additives, such as crosslinking agents.

Yet another embodiment of the invention relates to a process make time indicating devices that are not affected by temperature, for example by crosslinking a medium of the system.

Another embodiment of the invention relates to a process to make color changing or self-reading time indicating devices that have little or no effect of temperature.

Another embodiment of the invention relates to a process to make time indicating devices with little or no effect of temperature by introducing a counter balancing process and/or material in the device to nullify or minimize the effect of temperature.

Another embodiment of the invention relates to a process to minimize effect of temperature in an indicating devices by introducing a counter balancing process and/or material in the device to nullify or minimize the effect of temperature

Yet another embodiment of the invention relates to a to make time indicating devices with little or no effect of temperature by introducing an agent and/or a process for crosslinking a medium of the reaction to substantially counter balance the increase in rate of diffusion of an activator with an increase in temperature.

Yet another embodiment of the invention relates to a method to make time indicating devices with little or no effect of temperature wherein effect of one process substantially nullifies the effect of temperature of the other process.

Yet another embodiment of the invention relates to a method to minimize effect of temperature on a time indicating device by selecting a medium which provides an activator which acts at a constant rate, independent of temperature.

Yet another embodiment of invention relates to a method to minimize the effect of temperature by using a medium whose properties does not change with temperature.

Yet another main embodiment of invention relates to a method to minimize the effect of temperature on a time indicating device by using a crosslinked medium of the device.

Another embodiment of the invention is a method to prepare a two-tape time indicating device, wherein the device is activated by applying an activator tape on to an indicator tape.

Another embodiment is a method to prepare a two-tape time indicating device, wherein the activator has capability of crosslinking a medium of the indicator tape or a barrier layer on it.

Another embodiment is a method to prepare a two-tape time indicating device, wherein a medium or barrier layer is crosslinked by exposure to UV light, heat or pressure.

Another embodiment of the invention is a device for indicating freeze, thaw, temperature, time and time-temperature in any combination.

Another embodiment is a device for indicating freeze, thaw, time and high temperature.

Another embodiment is a device for indicating freeze, thaw and time.

Another embodiment is a device for indicating freeze and time.

Another embodiment is a device for indicating thaw and time.

Another embodiment relates to the processes of making the above described combination devices on the same substrate.

### BRIEF DESCRIPTION OF THE FIGURES

The foregoing and other objects, features and advantages will be apparent from the following description of the preferred embodiments of the invention as illustrated in the accompanying drawings, examples and preferred embodiment. The invention is more fully described below in conjunction with the figures wherein:

FIG. 1 shows a schematic cross sectional views of a basic two-tape time indicating device.

FIG. 2 shows a schematic presentation of a basic two-tape time indicating device with a permeable layer.

FIG. 3 shows a schematic presentation of a basic two-tape time indicating device with a wedge shaped permeable layer.

FIG. 4 shows strips of moving boundary time indicating devices similar to that of FIG. 3 and Example 1, annealed at different temperatures.

FIG. 5 shows a schematic presentation of effect on change in rate of reaction of diffusion of an activator and crosslinking by the activator with temperature wherein the net measurable effect on the rate is zero.

### DETAILED DESCRIPTION OF THE INVENTION

We have discovered that it is possible to develop simple time indicating devices by introducing a process which substantially counter balances the effect of temperature.

In order to more fully understand the invention as described below that following definitions are presented:

Activated device: A device where an activator layer of an activator tape is in direct or indirect contact with an indicator layer of an indicator tape.

Activator tape: A tape composed of at least one activator layer on a substrate, such as a plastic film.

Activator: A material which when reacts with an indicator develops a noticeable or measurable change, e.g., color, fluorescence, conductivity and opacity. Activator can be in form of a layer with a binder, e.g., on a substrate.

Diffusion: A process of migration of an activator or indicator through a medium or a barrier of the system. The words diffusion, permeation, movement or migration are used interchangeably herein.

Indicating devices: Devices or systems for monitoring processes and materials, such as time, temperature, time-temperature, humidity, freeze, thaw, doneness of foods, sterilization (including steam, ethylene oxide, formaldehydes, peroxide and plasmas), toxic chemicals and alike.

Indicator tape: A tape composed of at least one indicator layer on a substrate, such as a plastic film.

Indicator: A material which when reacts with an activator undergoes a noticeable or measurable change, e.g., color, fluorescence conductivity and opacity. Indicator can be in form of a layer with a binder.

Moving boundary device: An indicating device or system in which a boundary, border or ring is created by movement of an indicator or activator along the surface of the medium.

Service life: It is the maximum usable time of the device. The service life can be a shelf-life.

Two-tape device: An indicating device or system composed of (1) an indicator tape and (2) an activator tape. It can be activated (applied one over the other) or stored in an un-activated form (e.g., kept separated). It can have a flat or wedge shaped permeable barrier.

Un-activated device: Usually referred to a two-tape device wherein indicator and activator tapes are not in direct contact with each other.

The term “binder”, “medium”, “ink”, “paint”, “vehicle”, “coating” and “matrix” are also used interchangeably herein. The above definitions are of broad and of general nature.

The indicating system of the present invention can best be more fully described by reference to the figures. For simplicity and clarity of illustration, figures are not necessarily drawn to scale.

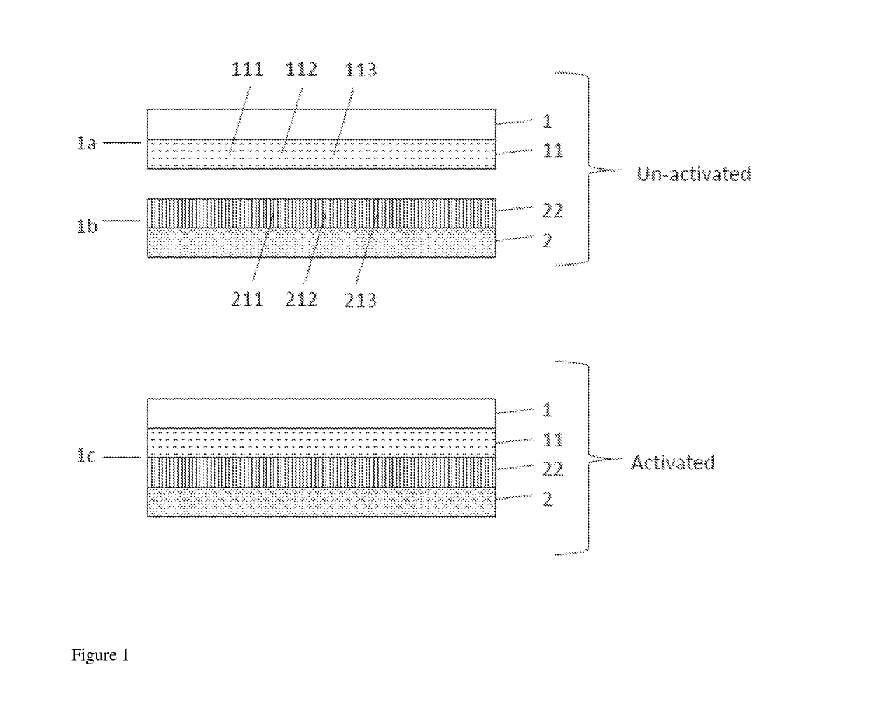

FIG. 1 shows cross sectional views of a basic un-activated and activated two-tape time indicting devices. In un-activated forms, the device is composed of two-tapes, an activator tape 1a and an indicator tape 1b. The activator tape 1a comprises a substrate 1 having thereon an activator layer 11 composed of an activator matrix 111 containing an activator 112 and required additives 113. The indicator tape 1b comprising a substrate 2 having thereon an indicator layer 22 composed of an indicator matrix 211 containing an indicator 212 and required additives 213. The indicator layer 22 can be a thin layer of metal with or without an oxide layer as disclosed in U.S. Pat. No. 8,343,437 which is incorporated herein by reference in their entireties. The matrix 111 can be an adhesive, such as a pressure sensitive adhesive (PSA). The device is activated 1c by applying the activator tape on to the indicator tape.

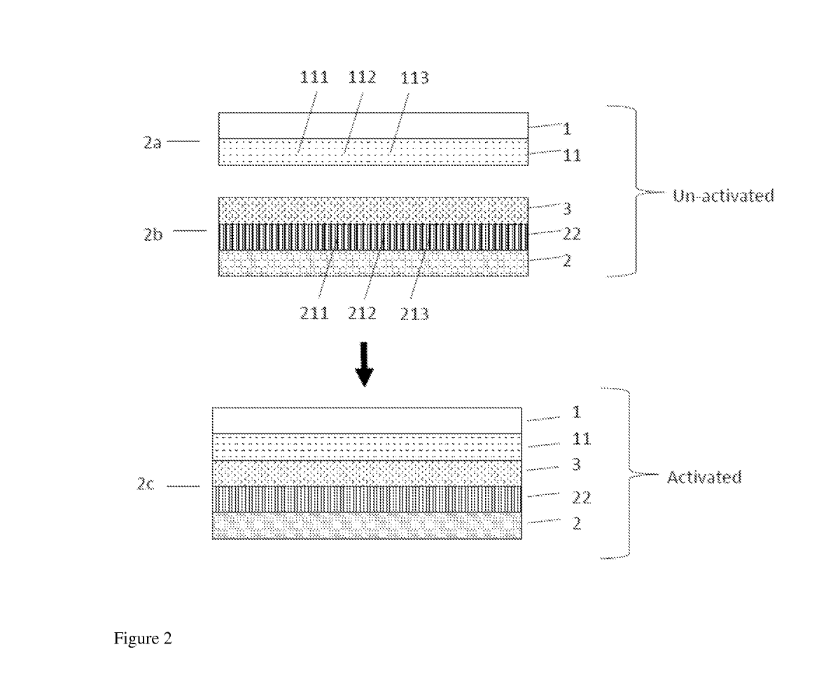

In order to vary the time and activation energy of the system, a permeable barrier layer can be applied on the indicator layer. FIG. 2 shows cross sectional views of a basic un-activated and activated two-tape time indicting devices having a permeable barrier layer. In un-activated forms, the device is composed of two-tapes, an activator tape 2a and an indicator tape 2b. The activator tape 2a comprises a substrate 1 having thereon an activator layer 11 composed of an activator matrix 111 containing an activator 112 and required additives 113. The indicator tape 2b comprising a substrate 2 having thereon an indicator layer 22 composed of an indicator matrix 211 containing an indicator 212 and required additives 213 and an additional barrier layer 3 permeable to the activator 112. The barrier 3 can also be permeable to the indicator 212. The indicator layer 22 can be a thin layer of metal with or without an oxide layer such as disclosed in U.S. Pat. No. 8,343,437. The matrix 111 can be an adhesive, such as a pressure sensitive adhesive (PSA). The device is activated 2c by applying the activator tape on to the indicator tape.

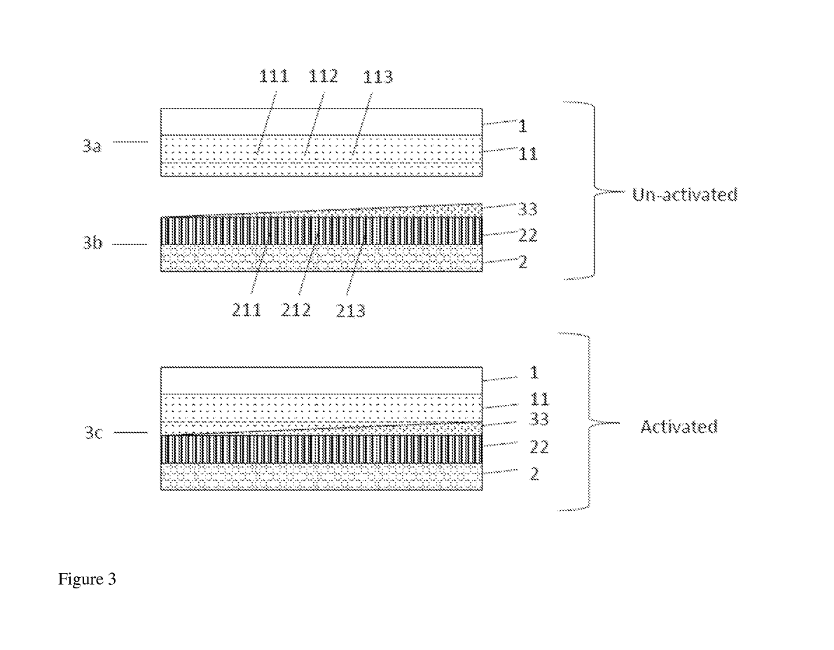

In order to create a moving boundary device as described in U.S. Pat. No. 8,343,437, the permeable layer 3 of FIG. 2 can be in the form of a wedge. FIG. 3 shows cross sectional views of a basic un-activated and activated two-tape time indicting moving boundary devices having a wedge permeable barrier layer 33. In un-activated forms, the device is composed of two-tapes, an activator tape 3a and an indicator tape 3b. The activator tape 3a comprises a substrate 1 having thereon an activator layer 11 composed of an activator matrix 111 containing an activator 112 and required additives 113. The indicator tape 3b comprising a substrate 2 having thereon an indicator layer 22 composed of an indicator matrix 211 containing an indicator 212 and required additives 213 and a wedge shaped barrier layer 33 permeable to the activator. The indicator layer 22 can be a thin layer of metal with or without an oxide layer as disclosed in U.S. Pat. No. 8,343,437. The matrix 111 can be an adhesive, such as a pressure sensitive adhesive (PSA). The device is activated 3c by applying the activator tape on to the indicator tape. The mechanism for creation of the moving boundary by the wedge shaped permeable/barrier layer is explained in U.S. Pat. Nos. 5,045,283 and 8,343,437 which are incorporated herein by reference in their entireties.

The indicating devices of FIGS. 1-3 can have many additional layers as disclosed in U.S. Pat. No. 8,343,437 and these additional layers are incorporated herein as reference. These layers can have any color, shape, thickness, size and nature as desired. The position of these and other optional layers relative to one another can often be changed and can often be interchanged. Most of these layers can be whole, partial or discontinuous. Some of these layers can be in form of a pattern, message or image.

The devices can have a PSA layer and a release layer on the back. The devices can be applied on an object by removing the release layer.

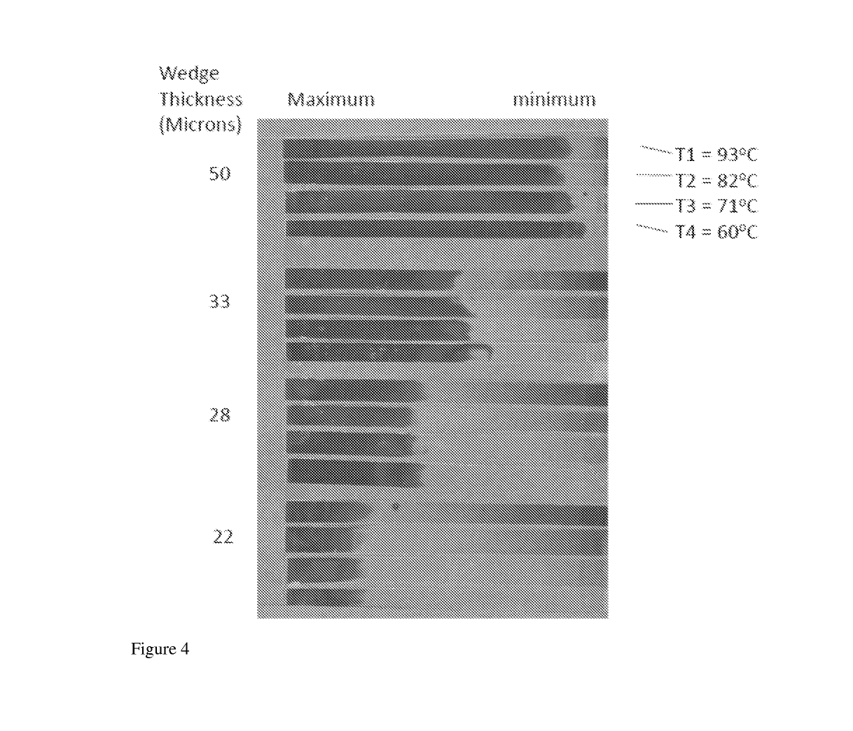

FIG. 4 shows strips of moving boundary time indicating devices similar to FIG. 3 annealed at different temperatures (e.g., 60, 71, 82 and 93° C.) for two weeks as described in Example 1. The indicator layer was a nano thin layer of aluminum as an indicator (commonly known as metallized/aluminized plastic film) and wedge shaped permeable barrier of PVPy of different thicknesses. The boundary between the etched and un-etched metal layer was created which moved with time from the thin end to the thick (right to left) of the wedge and then stopped and did not moved farther. The creation and movement of the boundary were recorded with a time lapsing photography. As can be seen from FIG. 4, the boundary moved to a certain distance then stopped irrespective of temperature of annealing. For a given nature and thickness of the wedge barrier, the movement of the boundary depend only on time and not temperature, i.e., the devices of FIG. 4 are time indicators. For a given thickness of the barrier film, the maximum distance traveled by the boundary depends only on the maximum thickness of the wedge barrier film and not on the temperature of annealing. The boundary moved father with thinner wedge (22 microns) compared to the thicker wedges (28, 33 and 50 microns). Even though we demonstrated the concept using a wedge shaped barrier, it is clear that a barrier layer of uniform thickness can be used. The movement of boundary of a two tape device independent of temperature is unique and novel is a preferred embodiment of this invention.

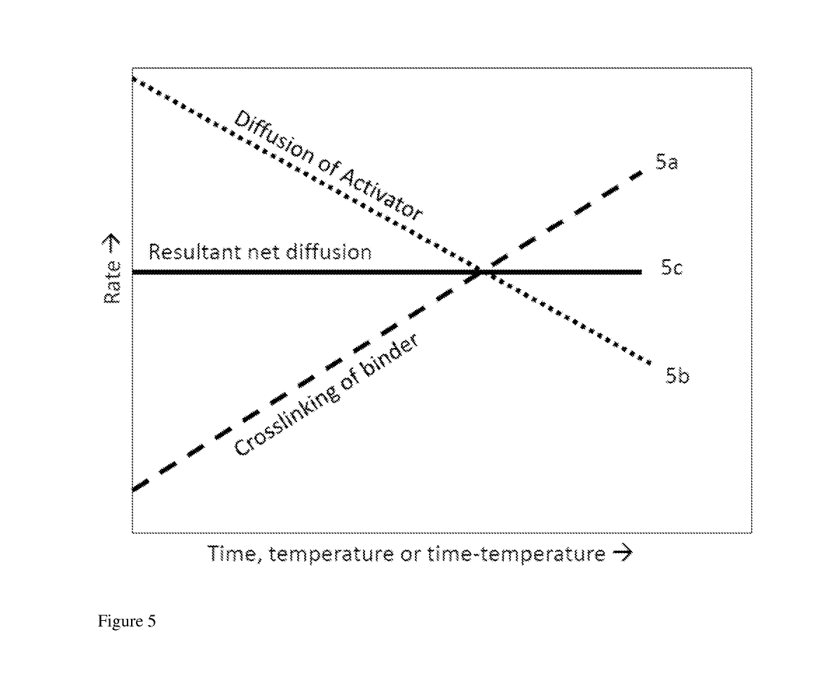

Typically, as the temperature of a reaction increases, the rate of reaction also increases. The activator of the devices in Example 1 was phosphoric acid (H₃PO₄, a tri-functional acid) and the barrier was polyvinylpyrrolidone (PVPy). Polyvinylpyrrolidone can be crosslinked by phosphoric acid. When the devices are activated, phosphoric acid diffuses through PVPy and crosslinks the polymer thereby decreasing its diffusion. When phosphoric acid is added in a solution of PVPy, the solution gels which indicates that phosphoric acid crosslinks PVPy. As the temperature increases, the crosslinking increases and a state is reached where the diffusion of phosphoric acid is essentially stopped. In the moving boundary device of Example 1, as the temperature increases the rate of crosslinking of the barrier polymer by the activator increases. However, the rate of increased in crosslinking slows down the diffusion of the activator through the binder. FIG. 5 shows a schematic presentation of plots of reaction rate versus time, temperature and/or Time-temperature of an indicating device. In this device, the decrease in rate of diffusion of the activator is caused by increased in rate of crosslinking of the barrier polymer by the activator with increasing time, temperature and/or time-temperature. Once maximum crosslinking is achieved, further diffusion of the activator is stopped. The results of this type of the devices are shown in FIG. 4. The movement of boundary of a diffusion based two tape device independent of temperature due to crosslinking of a medium by an activator is unique and novel is a preferred embodiment of this invention. Even though we demonstrated the concept with a moving boundary device, the permeable barrier layer can be of uniform thickness. Even though we demonstrated the concept with a metal layer as an indicator, the indicator can be any indicating composition which changes color with an activator.

This concept is equally applicable to devices other than two-tape devices, e.g., single or multilayer devices. The two-tape indicating devices are basically composed of an activator tape and an indicator tape as shown in FIG. 1. The two-tape device may have a permeable barrier material between the layers of the activator (a material, e.g., an acid which introduces a change, e.g., color change in the indicator) and indicator (a material, e.g., a pH dye or a nanometer thick metal layer which undergoes change in color or transparency when contacted with the activator) as shown in FIG. 2. The permeable barrier material which is usually a polymer, can be of a uniform thickness as shown schematically in FIG. 2 or in form a wedge (i.e., thin on one side and thick on the other) as shown in FIG. 3, can be introduced between the activator and indicator layers to delay the reaction.

In order to demonstrate feasibility of the concept, a moving boundary time indicating devices of FIG. 3 were made. The activator used was phosphoric acid in an acrylic PSA (pressure sensitive adhesive), the indicator was a very thin layer of aluminum (˜8 nm) on a plastic film (i.e., a metallized plastic film) with a layer of naturally formed aluminum oxide (˜1 nm) layer on the aluminum layer and the barrier material for the wedge shaped coating (0 micron on the thin end and 10 microns thick on the thicker end) made from different polymers. When the barrier material of the wedge was a non-crosslinking polymer, e.g., polyepichlorohydrin which cannot be crosslinked with the activator, e.g., with phosphoric acid, the rate of movement of the boundary was time and temperature dependent with activation energy of about 25 kcal/mole. When the barrier material of the wedge was crosslinkable (e.g., that made from PVPy) and the activator was phosphoric acid, the rate of movement of the boundary was essentially independent of temperature of annealing of the devices. In order to control the rate of movement of the boundary, the moving boundary devices of FIG. 3 were made with different thicknesses of PVPy wedge by using different concentrations of PVPy. The rate of diffusion of the activator (phosphoric acid which is also a crosslinking agent for the barrier polymer, PVPy) decreases as the temperature is increased because as more phosphoric acid diffuses in the barrier material (PVPy), the more it cros slinks the barrier and the more it reduces the diffusion of phosphoric acid and ultimately it prevents the diffusion of phosphoric acid. At one point the permeable barrier becomes essentially impermeable barrier. Thus, the effect of temperature is not only minimized but ultimately there is no effect of temperature. As the reaction proceeds either with time, temperature or time-temperature, a point is reached where the process is essentially stopped, e.g., a barrier will be so heavily crosslinked that it will prevent, essentially stop the diffusion of activator and/or crosslinking agent. This is the uniqueness of the devices and processes that after a certain time the reaction can come to a standstill.

The invention also relates to a process of making the indicating systems of the invention. In one embodiment, the indicating tape of the invention can be made by laminating an activator tape on an indicator tape. In another embodiment a layer of activator is coated on a layer of indicator with and without a permeable layer. In another embodiment, additional layers can be added to the indicating system.

In another embodiment, the activator and crosslinking agent can be oxygen, water/humidity, ionizing radiation, such as UV light, electrons and gamma/X-ray.

Most of the reactions are governed by Arrhenius equation. Hence, the rate of a reaction, including physical or chemical reactions of all indicators reported in the literature, increases as the temperature of the reaction increases and vice versa. All indicators reported in the literature have significant effect of temperature as their activation energy is between about 15-40 kcal/mole. Typically, the rate of a reaction doubles with every 10° C. rise in temperature and vice versa. We have discovered that the effect of temperature on the rate of a reaction, especially the rate controlling reaction, can be controlled by counter balancing its effect with another reaction. For example, a reaction producing an acid can be counter balanced by adding a reaction producing a base which neutralizes the acid and over all reaction rate will appear much slower even though the reaction rate of both reactions increases with temperature.

For a time indicating device, the increase in rate of reaction with increase in temperature is counter balanced by a process which substantially nullifies the effect of temperature to obtain a substantially net zero effect. There can be more than one counter balancing factor. The counter balancing factor can be a material or a process. The counter balancing factors can be two or more materials only. The counter balancing factors can be two or more processes.

An example of lowering the increase in rate of a reaction due to increase in temperature by a counter balancing factor is schematically shown in FIG. 5 with lowering rate of diffusion with crosslinking. Once maximum crosslinking is achieved, further diffusion of the activator can stop. The results of this type of the devices are shown in FIG. 4.

Another embodiment of the invention relates to a time indicating system which comprises a) an indicator tape and b) an activator tape, wherein the indicator tape comprises a substrate to which is affixed at least one layer of an indicator and the activator tape comprises at least one layer of an activator.

Yet another embodiment of the invention relates to a time indicating system which comprises a composite of an indicator tape and an activator tape, bonded together with at least one bonding layer wherein the indicator tape comprises a substrate to which is affixed at least one indicator layer and the activator tape comprises a layer of at least one activator.

As these devices are time indicators, they cannot normally be pre-made and frozen unless the activator is also gets frozen and does not diffuse or react. Once made or activated, they will be active and the processes, reactions, time will start. The device require proper designing so they can be activated when desired. They must be kept in an un-activated form and activated prior to use.

In order to make the indicating devices activatable on demand, one can use microencapsulated activator and/or indicator. The device can be created by applying a layer of microencapsulated activator which can be ruptured e.g., by application of heat or pressure.

Yet another embodiment of the invention comprises an indicating sealing tape, comprising a two-tape dispenser for the indicator tape and the activator tape, wherein the two-tapes are dispensed simultaneously when applying the sealing tape on a container.

The current technology offers an opportunity to make sealing tape and large labels. Activator and indicator tapes dispensed from a double-tape/two-tape dispenser and applied on a perishable box will seals the box and will also monitor time. The person opening the box will easily notice whether the items inside the box is of good quality, time or shelf life expired.

Tape dispensers are known in the art. Typically, a tape dispenser is comprised of a system capable of retaining and dispensing a single roll of tape. The two-tape dispenser is a dispenser for holding two rolls (activator and indicator rolls), mechanism for their lamination/activation and cutting laminated/activated tape of desired length. A box can be sealed with an indicator tape in form a large label and activated with an activator tape.

The packaging tape can be pre-activated by applying an activator tape on to the indicator tape, stored cold to stop the reaction till needed.

The sealing tapes and labels can have the many of those features of other indicating device described in this application, for example, other basic and optional layers to get moving boundary, barcodes, numbers, patterns, colors, images and messages.

The activated sealing tape can be applied only on the top closers/flaps or whole box and even crossing the previously applied activated sealing tape.

The indicating devices of current invention can have many additional layers. These layers can have any color, shape, thickness, size and nature as desired. The position of these and other optional layers relative to one another can often be changed and can often be interchanged. Most of these layers can be whole, partial or discontinuous. Some of these layers can be in form of a pattern, message or image.

The indicating device can be applied on to an object by removing the release liner and the release layer. The device can have many additional optional layers. These optional layers, such as top message layer, activation layer, tamper indicating layer and mask layers and are preferred embodiments of this invention. These optional layers may be composed of a microencapsulated material, such as an activator. Time indicating material containing micro-encapsulated activator can be activated either pressure or heat.

Another embodiment of the time indicating system of the invention comprises a system wherein an additional one or more layers are added to the system, wherein the layers are selected from a binder layer, a permeable layer, a wedge shaped permeable layer, a barrier layer, reactive layer, destroyable or degradable barrier layer, an expiration indicating layer, a tamper indicating layer, an activation indicating layer, a message or image creating layer or a separating layer, a removable layer, a disappearing layer, an activable layer, masking layer, a microencapsulated layer, thermally printable layer, and like, as are known in the art. The device can be a single coating as well.

The release layer can be composed of a nonstick material which does not bond or bonds very weakly with a PSA. The release materials include silicone, fluoropolymers such polytetrafluoroethylene, highly crosslinked resins, and oils. The preferred release material is a silicone and a fluoro-polymer.

A tamper indicating device can also be made by using the substrates made from a destructible/breakable plastic, such as polystyrene, polyvinyl chloride (PVC) and cellulose acetate. These and other tamper indicating materials and processes described in our US Patent Application No. 20120244623. The patents and references cited therein are incorporated by reference.

In another embodiment, the indicating system of the invention can also have at least one message which appears as a word or symbol on at least on one side of the indicator layer. The message can be in color. A message can be on or inside surfaces of any layer of the indicating system. In certain instances the system can contain at least two messages which do not start to become observable at the same time. An example is an indicator of the status or quality of an item when the indicating system is applied on or before the treatment of the item and a second message alone or in combination with the first indicating status or quality of the item after its treatment, such as, where the first message indicates un-doneness, freshness, usability, acceptability of the item and the second message alone or in combination with the first indicates doneness, spoilage, not usability and unacceptability of the item after a treatment or where the first message indicates non-sterile, non-usability, not-acceptability of the item and the second message alone or in combination with the first indicates doneness, sterile, usability and acceptability of the item after a treatment.

The surface of substrates can be printed with indicator either continuously or selected areas, e.g., lines or numbers. When the vapor of activator reaches the indicator it will introduce a color change. If a colorless indicator is printed in form of a message, e.g., lines or number, they will become visible. It is contemplated that any layer of the indicating system can contain a message or writing on either side of each layer. Required message(s) can be printed on or under the substrates of the system by common printing methods.

A crosslink is a bond that links one molecule, usually a polymer chain, to another, typically at more than one point. They can be covalent or ionic bonds. Polymer can be synthetic (e.g., polyacrylics) or natural (e.g., proteins and polycarbohydrates) and their derivatives. When crosslinks are added to rubbery or soft polymer molecules, the flexibility decreases, the hardness increases and the melting point increases as well. When polymer chains are linked heavily together by crosslinks, they lose some of their ability to move as individual polymer chains. For example, a liquid polymer (where the chains are freely flowing) can be turned into a “solid” or “gel” by crosslinking the chains together. Highly crosslinked polymers and their coatings are used as barrier materials to prevent diffusion of materials, such as oxygen, vapors and liquids. The reverse occurs when polymers are degraded.

Crosslinks can also be formed by chemical reactions that are initiated by reactive species, such as radicals generated by heat, pressure, change in pH or radiation. For example, mixing of an unpolymerized or partially polymerized resin with specific crosslinking agents results in a chemical reaction that forms crosslinks. Crosslinking can also be induced in materials that are normally thermoplastics through exposure to a radiation source, such as electron beam, gamma-radiation or UV light.

The crosslinking agents can be multi-functional, di tri, tetra etc. organic, inorganic and organo-metallic compounds. Crosslinking of polymers will depend upon the nature of the polymer. For example, polyphenols and proteins can be crosslinked with aldehydes, such as formaldehyde, glutaraldehyde, acrolein and polyfunctional inorganic compounds, such as osmium tetroxide. Multifunctional acids, such as citric acid can crosslink polymers like polyvinyl pyrrolidone (PVPy) and polyamines. Polyvinyl alcohol can be crosslinked by boric acid. Similarly, polyamine (e.g., polyethyleneimine can be crosslinked by multifunctional acids and inorganic polyvalent salts. Polyacrylic acid can be crosslinked by polyfunctional amines and polyvalent inorganic salts. The crosslinking can be done with bi or higher valent compounds, such as ZnCl₂ and AlCl₃. Crosslinkers can crosslink polymer immediately or slowly e.g., crosslinking of polyacrylics with aziridine is a slow process. Epoxies can be crosslinked with amines. Many polymers can be crosslinked with polymerizable crosslinking agents, such as 1,4-cyclohexanedimethanol divinyl ether, di(ethylene glycol) diacrylate, di(ethylene glycol) dimethacrylate, N,N-(1,2-dihydroxyethylene)bisacrylamide, divinylbenzene, p-divinylbenzene, ethylene glycol diacrylate, ethylene glycol dimethacrylate, 1,6-hexanediol diacrylate, 4,4-methylenebis(cyclohexyl isocyanate), 1,4-phenylenediacryloyl chloride, poly(ethylene glycol) diacrylate, poly(ethylene glycol) diacrylate, poly(ethylene glycol) dimethacrylate of various molecular weights, Poly(ethylene glycol) dimethacrylate of various molecular weights, tetra(ethylene glycol) diacrylate, tetraethylene glycol dimethyl ether and triethylene glycol dimethacrylate. Crosslinking can be initiated by catalysts or initiators as well.

Many polymers undergo oxidative crosslinking, typically when exposed to atmospheric oxygen or peroxides, such as hydrogen peroxide and inorganic oxidants.

An induction period (period during which no easily noticeable change either occurs or observable) can be obtained for the devices, methods and materials disclosed in U.S. Pat. Nos. 5,053,339; 5,045,283 and 8,343,437 and patents cited in them and they are incorporated herein by references. An induction period and lower activation energy of the indicating device can be obtained by having a high crosslinked layer from which it takes much longer for activator to diffuse through. Highly crosslinked material as a medium or barrier can also lower the effect of temperature to make them time indicating devices. It can also be obtained by coating a very hard, very difficult to diffuse layer, very hard to destroy layer or hard to diffuse through layer.

Reaction of the devices can be stopped by selecting a crosslinking agent which also freezes and by storing below the glass transition temperature (Tg) of polymer of the medium.

The reaction of the devices can be chemical or physical. The reaction can be organic, inorganic, organo-metallic or biological. The devices may have additives as required. The activator can be a pre-cursor for producing a crosslinking agent.

We demonstrated the concept of varying or minimizing the effect of temperature by crosslinking a medium or the barrier layer but effect of temperature can be varied or minimized by process, such as degradation, polymerization, depolymerization, decomposition, conversion, complexation, halogenation, dehydrohalogenation, precipitation, catalytic reaction, synthesis, displacement, acid-base, oxidation-reduction, neutralization, condensation, isomerization, hydrolysis, addition, elimination, substitution, rearrangement, adsorption-desorption, exchange, redox, gelling, swelling, change in viscosity or hardness, density/specific gravity and solubility. These are some of the processes that can be used for varying the effect of temperature or controlling the rate of the reaction and the activation energy. Basically, any process or material which can counter the effect of temperature can be used to make the time indicating devices with little or no effect of temperature.

There are many pairs of indicators and activators that can be used for the devices proposed here. Any chemical which can react with another material and can introduce a noticeable or measurable change can be used as an activator. Activators can have a co-activator. Co-activator can be a moderator/modulator and can increase or decrease the effect of an activator as desired. Sometimes two activators can have synergistic effect. A solvent, wetter, surfactant or plasticizer can also be used as co-activator. The terms, co-activator, moderator and modulators are used interchangeably herein.

The activator can be a gas, liquid, semi-solid or solid. Preferred activator is a liquid or solid which can diffuse through a polymeric medium. Activators can be monomeric, oligomeric, polymeric, mono-functional or multi-functional compounds.

When a pH dye is used as an indicator, one can use an acid or a base as an activator for the devices. A variety of amines are available which can be used as a base for the pH dye. Amines, such as primary, secondary, tertiary and quaternary amines of mono or multi-substituted or un-substituted aliphatic, acyclic and aromatic compounds can be used as activators for some of the devices. Examples of amines and their salts include: adamantanamine, adenine, amino cyclohexanol, amino diethylaminopentane, amino dodecanoic acid, amino ethyl dihydrogen phosphate, amino ethyl hydrogen sulphate, amino pentenoic acid, amino propyl imidazole, amino propyl pipecoline, amino sorbitol, amino undecanoic acid, amino-butanol, aminodeoxy-d-sorbitol, aminoethyl dihydrogen phosphate, aminopropyl imidazole, ammonium acetate, ammonium bromide, ammonium carbaminate, ammonium carbonate, ammonium chloride, ammonium dihydrogen phosphate, ammonium ferrocyanide hydrate, ammonium formate, ammonium hydrogen carbonate, ammonium hydroxide, ammonium iron (11) sulfate, ammonium iron (111) citrate, ammonium iron (111) oxalate trihydrate, ammonium nitrate, ammonium per sulfate, ammonium phosphate dibasic, ammonium sulfamate, ammonium sulfate, benzyl-n-methylethanolamine, benzyltrimethylammonium chloride, bis(dimethylamino) benzophenone, chloroethylamine monohydrochloride, chlorohydroxypropyl trimethyl hydrochloride, chloronitroaniline, choline, choline chloride, choline hydroxide, choline iodide, cyclohexyamine, decylamine, diallyl dimethyl ammonium chloride, diaminodiphenylamine, diaminododecane, diaminoheptane, diaminohydroxypropane, diaminononane, diaminooxapentane, diaminopropane, dibutylamino propylamine, dibutyl amino benzaldehyde, diethanolamine, diethyl amine, diethyl aminopropylamine, diisopropyl ethylamine, dimethyl amine, dimethyl amino ethylmethylamino ethanol, dimethyl amino benzaldehyde, dimethyl aminopropoxy benzaldehyde, dimethyl aminopropylamine, dimethyl ammopyridine, dimethyl glycine, dimethyl glyoxine, dimethyl imidizole, dimethyl imidazolidinone, dimethyl propane-diamine, diphenylamine, diphenylamine, diphenylbenzidine, dodecylamine, dodecyltrimethylammoniumbromide, ethanolamine, ethanolamine hydrochloride, ethyl amine, ethyl aminobenzoate hydrochloride, glycidil trimethyl ammonium chloride, histidine, hydroxylamine hydrochloride, hydroxylamine sulphate, imidazole, imidazolidone, iminodiacetic acid, methyl amine, methyl imidizole, nitro aniline, nitro diphenylamine, octa decylamine, phenylenediamine, polyethylenimine, tetrabutyl ammonium hydroxide, tetrabutyl ammonium iodide, tetraethylammonium bromide, tetraethylammonium hydroxide, tetrafluorophenylimidizole, tetrahexylammonium bromide, tetramethyl ammonium acetate, tetramethyl ammonium chloride, tetramethyl ammonium hydroxide, tetramethyl ethylenediamine, tetramethyl ethylethylenediamine, tetramethyl hexanediamine, tetramethyl propanediamine, tetramethyl guanidine, triallylamine, triethanolamine, triethylamine, triethylenetetramine, triethylenetetramine hydrochloride, triethylethylenediamine, tridecylamine, trimethyl ammonium chloride, trimethyl-propanediamine, trimethylamine hydrochloride, trioctylamine, trioxa-tridecanediamine, triphenylamine, tris(hydroxymethyl) aminomethane and tris(methoxyethoxy) ethylamine.

Organometallic compounds containing bonds between carbon and a metal can be used as activators. Examples of such organometallic compounds include all Gilman reagents, which contain lithium and copper. Tetracarbonyl nickel and ferrocene are examples of organometallic compounds containing transition metals. Other examples include organomagnesium compounds like iodo(methyl)magnesium MeMgI, diethylmagnesium (Et₂Mg), and all Grignard reagents; organolithium compounds, such as n-butyllithium (n-BuLi), organozinc compounds, such as diethylzinc (Et₂Zn) and chloro(ethoxycarbonylmethyl)zinc (ClZₙCH₂C(═O)OEt); and organocopper compounds, such as lithium dimethylcuprate (Li⁺[CuMe₂]⁻). They also include metal-containing compounds lacking direct metal-carbon bonds but which contain organic ligands. Metal beta-diketonates, alkoxides, and dialkylamides are representative members of this class. Many complexes feature coordination bonds between a metal and organic ligands. The organic ligands often bind the metal through a heteroatom, such as oxygen or nitrogen, in which case such compounds are considered coordination compounds. Furthermore, many lipophilic compounds, such as metal acetylacetonates and metal alkoxides, called “metalorganics” can also be used.

Solids which do not generate vapor may not be very effective activator. However, a solid dissolved in another solvent/liquid or sublimeable solid which can be carried along with the vapor of activator can be effective.

The preferred indicator is a nano thick metal or metal alloy layer but it can be any other, e.g., pH dye layer disclosed in U.S. Pat. Nos. 5,053,339; 5,045,283 and 8,343,437 and patents cited in them and they are incorporated herein by reference.

Acids, bases and salts can be used as activators and hence if desired their reaction can be monitored with pH, cation and anion sensitive dyes. For example, bromophenol blue when exposed to a base, such as sodium hydroxide turns blue. When blue-colored bromophenol blue is exposed to acids, such as acetic acid it will undergo a series of color changes, such as blue to green to green-yellow to yellow. Aluminum ion reacts with alizarins to give a red precipitate; copper ions react with cuproine to give a pink purple color, ferrous ion gives a red color with 2,2′-dipyridyl, ferric ion reacts with potassium ferrocyanide to give a blue color, magnesium ion gives a blue color with magnesium and nickel ion reacts with dimethylglyoxime to give a red color. Test methods are also well known for the detection of inorganic compounds, their cations and anions, which are associated with a color change. These reactions and corresponding compounds can also be used in the device, especially if a color change is also desired. Inorganic compounds and indicators for their detection are described in references: J. Bassett, R. C. Denney, G. H. Jeffery and J. Mendham, Vogel's Textbook of Quantitative Inorganic Analysis, Longman Scientific and Technical, p. 294, 1986; Fritz Feigl, Vinzenz Anger and Ralph E. Oesper, Spot Test in Inorganic Analysis, Elsevier Publishing Company, 1972, p. 526-616; Products for Analysis, Catalog of Hach Company, 1986-87 (are cited as references herein).

Indicators are typically dyes or compounds which react with activators to introduce a color change can be used as indicators. These are typically pH dyes. The preferred material is a colored dye which becomes colorless when contacted with the activator or vice versa. The reaction between the activation indicator and the activator should preferably occur fast in seconds to minutes.

A large number of reactions are associated with a change in fluorescence rather than a color change in the visible region. Such compounds can be used as indicator. All colors herein can also be fluorescence colors as well. List of indicator dyes that can be used are listed in Tables 1-3 of U.S. Pat. No. 5,053,330, incorporated herein by reference in its entirety.

The indicator and activators layers will be composed polymeric materials, at least one of them being a pressure sensitive adhesive (PSA). Type of adhesive that can be used includes hot melt, PSA, repositionable, or film, such as polyethylene. Barrier polymer can be wedge shaped. Thinner matrix is preferred as thicker will require more quantity of activator. Adhesives or viscoelastic materials, for example, include the use of synthetic elastomers, acrylates, silicone, synthetic latex and vinyl acetate, as representative examples of PSA are one of the preferred material as a binder. Included are pressure sensitive adhesives having an elastomer or rubbery polymer as the elastic component and a low molecular weight tackifying viscous component. Common rubber based pressure sensitive adhesives include natural elastomers, synthetic elastomers, such as polychloroprene, polyurethane, and random and block copolymers of styrene-butadiene, styrene-isoprene, polyisobutylene, butyl rubber, and amorphous polypropylene. An illustrative, but by no means exclusive, list of viscoelastic materials which may be suitable for use with the indicator of the present invention includes natural rubber, butyl rubber, polybutadiene and its copolymers with acrylonitrile and styrene, poly alpha olefins, such as polyhexene, polyoctene, and copolymers of these and others, polyacrylates, polychloroprene, silicone pressure sensitive adhesives, and block copolymers, such as styrene-isoprene block copolymers, and mixtures of any of the above. The pressure sensitive adhesive can comprise, for example, a polyisoprene, atactic polypropylene, polybutadiene, polyisobutylene, silicone, ethylene vinyl acetate, or acrylate based pressure sensitive adhesive, and can typically include a tackifying agent and/or a plasticizing agent. The adhesives also include isooctyl acrylate (IOA) or isooctyl acrylate/acrylic acid (IOA/AA) based pressure sensitive adhesive.

Common acrylic adhesives, such as polymers of 2-ethylhexylacrylate, butyl acrylate, ethylacrylate, and acrylic acid can be used. These acrylic adhesives are inherently pressure sensitive. Polymers and copolymers of vinyl ethers, such as vinylmethylether, vinylethylether and vinylisopropylethers are used as pressure sensitive adhesives. Two types of silicone gums; 1) all methyl based and 2) the phenyl modified can also be used as pressure sensitive adhesives. The silicone resin is used as a tackifier and by adjusting the resin to gum ratio, they can be made with a wide range of adhesion properties. High silicone gum content adhesives are extremely tacky. Silicone adhesives are also crosslinked (cured) by catalysts, such as benzoyl peroxide and amino silane.

A PSA which is least affected by activator or does not affect activator is preferred. PSA is preferred but any other adhesives, such as hot melt adhesive can be used. For certain devices, such as time indicating devices or visitor badges, it is preferred that the bonding of the PSA layer is much stronger with the indicator layer so it can't be easily tampered. UV and peroxide curable adhesive can also be used.

Hot melt pressure sensitive adhesives typically comprise a block copolymer, a tackifying resin and a plasticizing oil can also be used. The block copolymer provides flexibility, integrity and smooth peel adhesion properties. It also further provides a medium for dissolution or suspension of the tackifying resin and the plasticizing oil. The tackifying resin enhances tack properties and adhesion and reduces viscosity and the plasticizing oil reduces peel values, viscosities, glass transition temperatures and storage modulus and increases flexibility.

Tackifiers are chemical compounds used in formulating adhesives to increase the tack, the stickiness of the surface of the adhesive. They are usually low-molecular weight compounds with high glass transition temperature and softening temperature above room temperature, providing them with suitable viscoelastic properties. In hot melt adhesives they can comprise up to about 40% of total mass. Tackifiers are usually resins (e.g. rosins and their derivatives, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, and their mixtures, terpene-phenol resins (used often with ethylene-vinyl acetate adhesives)). Many pressure-sensitive adhesives are a blend of rubbers (natural or synthetic) and a tackifying resin. Some acrylic adhesives also include an additional tackifier. Silicone rubber-based pressure-sensitive adhesives require special tackifiers based on “MQ” silicate resins, composed of a monofunctional trimethyl silane (“M”) reacted with quadrafunctional silicon tetrachloride (“Q”).

Many water soluble/swellable polymeric systems, such as those based on plasticized and unplasticized polymethyl methacrylate, polyethylene glycol, cellulose ethers, PVPy, polyvinyl methyl ether, polyaminomethylmethacrylate, polyacrylates, copolymer of methyl and/or ethylesters of acrylic acid and methacrylic acid, vinyl pyrrolidone/vinyl acetate, vinyl pyrrolidone, methacrylic acid, methyl methacrylate and natural products, such as dextrin, gelatin, casein and starch can also be used a binder/PSA for activators and indicators, especially for monitoring humidity/moisture. The system described in U.S. Pat. Nos. 4,215,025; 4,331,576; 4,490,322; 4,775,374; 5,133,970; 5,296,512; 5,296,512; 5,395,907; 5,565,268; 6,326,524; 6,444,761 and 7,465,493; EP1458366; U.S. Patent Applications 20090018514; 20090030361 and 20090062713 and WO/1995/005416; WO0230402; WO0021582 and WO 0154674 and references, formulations and processes cited therein can also be used as a binder for activator and indicator. These patents and patent applications are hereby incorporated by reference into the specification of the present invention.

Materials which form a gel can also be used as a binder. Polymers which are crosslinked or can be crosslinked can also be used. They include natural and synthetic polymers, such as gelatin, agar, agarose, “Super Slurper”, which is a sodium salt of 60% graft copolymer of starch, polyacrylamide and acrylic acid. The advantage of using Super Slurper (commercially available from the Aldrich Chemical, Milwaukee, Wis.) is that a gel can be formed at room temperature without the necessity of heating followed by cooling to room temperature. One can use a variety of polymers, copolymers and their mixtures as binders to get desired properties, such as high gel strength and high gelling temperature. Polymers which can retain solvent or activator are preferred. Water insoluble polymers which form a gel in a combination of solvent and nonsolvent can also be used for this device. Reversible gel forming polymers listed in the following books and reviews can also be used: (1) “Reversible Polymeric Gels and Related Systems”, Paul S. Russo, ACS Symposium Series #350, Washington, D.C., 1987; (2) L. L. Hench and J. K. West, Chem. Rev., 90, 33 (1990); (3) “Hydrogels” reported by Nagasaki and K. Kataoka, in Chemtech, p 23 Mar. 1997; E&E News, Jun. 9, 1997 p 26, Encyclopedia of Polymer Science Technology, 7, 783 (1986); (4) “Reversible Crosslinking”, Encyclopedia of Polymer Science Technology, 4, 395, (1986), L. Z. Rogogovina and G. L. Slonimiski, and Russian Chemical Review, 43, 503 (1974) and (5) “Polymer Handbook” by A. Hiltner, Third Edison (J. Brandrup and E. H. Immergut Eds), John Wiley and Sons, New York, N.Y. 1989.

Thickness of the binder for activator and indicator layers can be in the range of 0.001 mm to 0.1 mm.

Permeable layer as defined herein is a layer which is permeable to activator. Any material which lets activator diffuse or migrate through under controlled conditions can be used to make a permeable layer. Preferred permeable layer is a polymer. The nature of the permeable layer will depends on the activator. It is mainly used to vary/increase the time required for the transparency change and vary the activation energy of the reaction/device. Permeable layer materials include glassy polymers, semi-crystalline polymers, physically and chemically crosslinked elastomers, segmented polyesters, polyamides, radiation crosslinked polybutadiene, and pressure sensitive adhesives. Examples of suitable glassy polymers include polystyrene, polyvinyls, and halopolymers, such as polyvinylchloride, polyepichlorohydrin and acrylates, such as polymethyl methacrylate. Examples of suitable semi-crystalline polymers include polyethylene, polypropylene and polyesters. Examples of suitable physically crosslinked elastomers include triblock copolymers, such as styrene-isoprene-styrene block copolymers, and segmented polyurethane elastomers. An example of a suitable chemically cross-linked elastomer is sulfur crosslinked natural rubber. In the one embodiment, the permeable layer material is a pressure sensitive adhesive including acrylic pressure sensitive adhesives, silicone pressure sensitive adhesives, rubber resin blend pressure sensitive adhesives, triblock copolymer pressure sensitive adhesives, and vinyl ether polymer pressure sensitive adhesives. Rubber resin blend pressure sensitive adhesives include natural rubber, polybutadiene, polyisobutelene, styrene butadiene random copolymers, synthetic polyisoprene, and butyl rubber. Useful triblock copolymer pressure sensitive adhesives include styrene-isoprene-styrene copolymers, styrene-butadiene-styrene copolymers, styrene-ethylene butylene-styrene copolymers, and styrene-ethylene propylene-styrene copolymers. Commercially available latexes, and the raw (without any color) materials for making inks, paints, lacquers, varnishes and adhesives can be used as a permeable layer materials. Thickness of the permeable layer can be in the range of 0.001 mm to 0.1 mm. A permeable layer can have a neutralizer of an activator.

Polyvinyl alcohol, polyvinyl acetate, partially hydrolyzed polyvinyl acetate, polyvinyl ether, cellulose derivatives, such as nitrocellulose, cellulose acetate, cellulose acetate butyrate, methyl cellulose, ethyl cellulose, gums, such as guar gums, starch, proteins, such as gelatin can be used as permeable layer.

Water soluble polymers can also be used as a binder for activator, adhesive and permeable layer. The examples of water soluble polymers include: agar, agarose, alginic acidamylase, beta-glucan, carboxymethylcellulose, carrageenan, cellulose etherschicle gum, chitin, dammar gum, ethylcellulose, gelatin, gellan gum, guar gum, gum arabic, gum ghatti, gum tragacanth, gum xanthan, hydroxy ethyl cellulose, hydroxy ethyl starch, karaya gum, locust bean gum, mastic gum, partially hydrolyzed polyacrylamide, poly acrylamide, poly acrylic acid, poly crotonic acid, poly hydroxy-2-ethylmethaacrylate, poly hydroxy-3-butyric acid, poly lysine, poly methacrylic acid, poly methyl vinyl ether, poly propylene glycol, poly vinyl acetate—partially hydrolized, poly vinyl alcohol, poly vinyl methyl ether, poly vinyl phenol, poly vinyl pyrrolidone, polyacrylates, polyacrylic acids, polyallylamine, polyaminoacids, polyethylene/acrylic acid, polycarboxylates, polyethylene glycol, polyethyleneimine, polystyrene sulfonic acid, polyvinylamine, PVPy, sodium alginate, spruce gum, tara gum, xanthan gum, their copolymers, block copolymers, derivatives, including copolymers with water insoluble polymers. Water soluble polymers are preferred binders for activator for thaw indicating device because when water is used as a solvent for activator, it can freeze the whole layer and may either prevent or minimize the migration of activator and provide controlled release of the activator.

Activator, indicator, additives or the product of reactions, preferably should not permeate through the substrates. A substrate for the device which is substantially impermeable to the components of the device is a preferred substrate.

Any solid substrate can be used as a substrate for the indicating device. Preferred substrate is a flexible plastic film of natural and synthetic polymers. Fiber reinforced substrate can be used for sealing tape indicating device. Plastic substrate can be self-colored (pigmented) or coated with a color layer. It can be transparent, semi-transparent, translucent or colored with various intensities. The polymer films include polyolefins (linear or branched), polyamides, polystyrenes, nylons, polyesters, polyurethanes, polysulfones, styrene-maleic anhydride, styrene-acrylonitrile, ionomers based on sodium or zinc salts of ethylene methacrylic acid, polymethyl methacrylates, cellulosics, acrylic polymers (acrylates, such as ethylene methacrylic acid, ethylene methyl acrylate, ethylene acrylic acid and ethylene ethyl acrylate), polycarbonates, cellophane, polyacrylonitriles, ethylene-vinyl acetate and their copolymers can be used as substrate for the devices. The preferred substrates are polyethylene, polypropylene, polyester, cellulose acetate, polyvinyl chloride and their copolymers. These substrates can be metallized.

One may have use high barrier film, such as EVOH (ethylene vinylalcohol copolymer) or plastic films coated with aluminum oxide and silicone oxide impermeable substrates are preferred. Impermeable to any component of the device, heat sealable, coatable, and transparent top and preferably opaque as the bottom, metallized films are preferred for the bottom substrate. Substrate should be non-permeable to all components of the devices.

In order to avoid of undesirable, adverse effects of ambient conditions, such as humidity, oxygen, carbon dioxide and UV light, one may select materials for the devices which are either not affected by them or protect them. If the materials are humidity sensitive, the effect can be minimized by selecting barrier films which minimize the diffusion of humidity in the devices. If the materials are UV sensitive, one can add UV absorbers in the system and/or select substrates which are UV absorbing. Similarly, if a materials diffuses out of the substrate, one can select a substrate, such as high barrier films as substrate and the system can be seals from all sides.

If an indicating device has an indicator for any other material or process, one can create a double indicator, for example, the indicator changing color with temperature and also with time and temperature. Another way of creating multi-sensor devices is to add one indicating devices on, below or on the side of the current devices.

The devices can be made with service life of hours to years. Preferred service life is 1 to 30 days. The activation energy of the devices can be varied from minus 10 to 100 kcal/mole, preferred ranges are minus 5 to 10 kcal/mole for time indicating devices and higher for other devices. The devices can be made to use from −40° C. to 200° C. The preferred temperature range −20° C. to 60° C. The concentration of activator can be varied from a few percent to 90%. Preferred concentration of activator is 5 to 50%. The concentrations of indicator can be varied from a 0.1 to 100%. Preferred concentration is 1-10%. The thickness of the indicator, activator and barrier layers can be from a 10 nm to 1 mm, preferred thickness is 10 to 100 microns, the thickness of substrates can be from 10 microns to 1 mm, preferred thickness is 10-100 microns.

The device can also be in form of a very long tape which can be applied on any object including boxes of items to be monitored or cut into small pieces and applied on individual object. The device can also be in form of small to large labels, stickers and alike.

If a metal layer is used as an indicator, the time indicating devices can be a RFID (radio frequency identification device) as disclosed in U.S. Pat. No. 8,343,437 and patents cited in them and are incorporated herein by references. The devices can be made by using a mixture of indicator (e.g., metal powder or a pH dye), activator (e.g., an acid), binder and a crosslinking agent.

Another embodiment of the invention relates to a time indicating system which can monitor a material or a process. More preferred is the indicating system wherein the material is a chemical agent and the process is time, temperature, time-temperature, freeze, thaw, humidity, doneness of food, microwave, pressure, radiation and sterilization including, for example, sterilization with steam, ethylene oxide, peroxide, plasmas of peroxide, formaldehyde, dry heat and ionizing radiation.

Another embodiment of the invention is a process to monitor the status of medical products, food, or biological waste which comprises placing the indicating system on the packaging of such medical products, food, or biological waste.

Another embodiment is a process to monitor a perishable item by placing the indicating system on or near the perishable item wherein the perishable item is a food item, or a nonfood item. More particularly one can monitor the limited time consumer use for items that have been on or the item to be monitored, wherein the item is selected from the group of drinks, food items, health, personal and family care products.

In another embodiment of the invention the time indicating system is used to indicate time, such as shelf-life, use-by, best-by or sell-by time of a perishable wherein the perishable is a food item, such as fresh, refrigerated, or frozen, vegetables, fruits, meats, fish, poultry, dairy products, bakery products, juices, pre-cooked foods, soft and alcoholic beverages, or a nonfood item, such as a pharmaceutical, vaccine, biological sample, such as sera, blood, or blood plasma, cosmetics, battery, reactive chemical compound or a biochemical product.

In another embodiment of the invention the time indicating system is applied on or used as, for example, in, for or on a safety sticker, self-timing retail sticker, biological industrial process monitor, self-expiring sticker to prevent re-use, security ID label, visitors badge, self-expiring parking tag, package and shipping label, wrist band, time indicating ticket for trains, buses, spot events, theaters etc., self-expiring pass for tours, emergency rooms, hospitals, museums, and other locations, race track pass, security label for screened luggage, purse, bag at airports to indicate that such items have been inspected, and at unmanned but video controlled entrances for visitors where a self-expiring visitor label is issued electronically. In addition, the indicating system can be used to indicate limited time consumer use for items that have been opened or in use and should be used within certain period, including but not limited to drinks, food items, health, personal and family care products. Also included are “gimmick” type applications, such as in toys, gimmick, messages, patterns, designs, gift cards, and greeting cards.

Also contemplated within the invention is an indicating system which is in the form of a safety sticker, self-timing retail sticker, biological industrial process monitor, self-expiring sticker to prevent re-use, security ID label, visitors badge, self-expiring parking tag, package and shipping label, wrist band, time indicating ticket for trains, buses, spot events, theaters, self-expiring pass for tours, emergency rooms, hospitals, museums, and other locations, race track pass, security label for screened luggage, purse, bag at airports to indicate that such items have been inspected, and at unmanned but video controlled entrances for visitors where a self-expiring visitor label is issued electronically.

In another embodiment, the indicating system is in the form of a toy, gimmick, message, pattern, design, gift card and alike.

The devices can be in form of band or foldable modifications. The activator and indicator tapes can be attached or directly coated/applied at different locations and sides on a substrate which is in form of a strip or open band. A band can also be created by jointing activator and activator tapes at the ends. They can be joined by many sealing methods, such as with an adhesive or by ultrasonic welding.

In another embodiment of the invention is compositions and methods of varying the activation energy, e.g., by lowering the activation energy of diffusion based devices by crosslinking and increasing by using agents which degrades the binder. The rate of reaction with temperature can be accelerated by degradation of the medium, thereby increasing the diffusion of the activator with temperature.

The rate of reaction and/or activation energy of the devices can be varied, especially lowered by more than one variables. Activator can be a crosslinking agent or a crosslinking agent can be added in the activator to crosslink the medium, such as barrier layer which can be polymeric. One can vary the rate of a reaction and the activation energy by varying the nature and concentration of crosslinking agent. It is also possible to achieve negative Ea by the methods, materials and devices disclosed herein.

Color change in the device can be obtained by adding one component while crosslinking by the other component in the activator layer. The rate of reaction and the activation energy can be varied by changing the viscosity, such as thixotropic and rheopecty (or rheopexy) properties of a polymeric medium. They can also be varied by varying the hardness of the medium.

Another embodiment is an indicating system wherein the service life or shelf life of the system is varied or adjusted by changing one or more of the parameters selected from the group of: nature and thickness of activator, indicator and barrier layers and nature and quantity of activator, indicators and additives, such as crosslinking agents.

The service life (e.g., time required for the boundary to travel a certain distance or a color change) and the activation energy of the current indicating devices can be varied by one or more of the following major parameters, such as (1) Nature and thickness of activator, indicator and barrier layers and (2) Nature, concentration and quantity of activator, indicator and additives, such as crosslinking agents.

The above and those disclosed herein are some common examples of possible variations, alterations, modifications and options of the materials, devices and processes. By permutation—combination, it is possible to have a very large number of variations, modifications and options for the devices and processes, e.g., by changing properties of components, position of a layer, multiplicity of a layer, adding an extra layer, changing nature of additives, activators, indicator, adding image/message, by varying the size and shape of a layer or the device, varying nature of the materials, and many other parameters including those mentioned in this application.

The current inventions can be used to improve performance of a large number of the prior art indicating devices by many different ways. Inventions disclosed herein can be combined with prior art compositions, processes and devices to make best of the both technologies.

The following examples are illustrative of carrying out the claimed inventions but should not be construed as being limitations on the scope or spirit of the instant inventions.

### EXAMPLES

### Example 1

### Preparation of Moving Boundary Time Indicating Devices

1A. Preparation of the Activator Tape:

A 50 micron×30 cm×45 cm clear polyester film was coated with a polyacrylic pressure sensitive adhesive containing phosphoric acid (2 g of 85% phosphoric acid in 30 g of 40% polyacrylic PSA in ethyl acetate, isopropanol and toluene mixture) with a 250 micron coating bar and dried in an oven at 70° C. for 15 minutes, similar to that shown schematically in FIG. 3A.

1B. Preparation of the Indicator Tape with a Wedge Shaped Polymeric Barrier Layer:

A 50 micron×30 cm×45 cm metallized polyester film having ˜8 nm thick aluminum layer with a naturally formed oxide layer (˜1 nm) was coated on the metal side of the film with 0-250 micron wedge shaped coating bar (5 cm long) with solution of different concentrations of PVPy (PVPy) in isopropanol and the coatings were dried in an oven similar to that shown schematically in FIG. 3B.

1C. Activation of the Time Device:

The activator tape of example 1A was applied/laminated on to the indicator tape of example 1B with barrier layer in contact with the activator layer, similar to that shown schematically in FIG. 3C. The devices were cut into small strips (˜0.5 wide), each strip having the same wedge shaped barrier layer were mounted on a red color paper and assemblies were annealed at different temperatures.

1D: Results:

After some hours of annealing a boundary was created between un-etched and etched metal layer. The boundary moved from the thin end of the wedge barrier to the thick end. The movement of the boundaries was recorded with a time lapsing camera and a computer with a proper software. The boundary moved faster in the beginning and slowed down with time and stopped moving completely after about one week irrespective of the temperature of annealing as shown in FIG. 4.

After two weeks, the strips were removed and were mounted according to the thickness of the maximum thickness of the wedge (referred as wedge thickness) as shown in FIG. 4. As can be seen from FIG. 4, for a given wedge thickness, the distance traveled by the boundaries is independent of the temperature of annealing, a true time indicator.

### Example 2

### Preparation of Color Changing Time Indicating Devices

Color changing time indicating devices similar to example 1 were prepared using (1) the activator tape of Example 1A and (2) indicator tape similar to Example 1B composed of a layer of pentamethoxy triphenyl methanol (a pH dye) in polyepichlorohydrin as binder on a polyester film, instead of metallized plastic film and a wedge shaped layer of polyvinyl pyrrolidone (PVPy) as a barrier layer. The device was activated by applying the activator tape on to the indicator tape as described in Example 1C. After about 30 minutes a red colored, slightly diffuse boundary appeared at the thinner end of the wedge and with time the boundary moved towards the thicker end of the wedge. The boundary was not as sharp as that of Example 1. After about two days irrespective of the temperature of annealing the boundary stopped moving further.

Although the devices and methods of the present disclosure have been described with reference to exemplary embodiments thereof, the present disclosure is not limited thereby. Indeed, the exemplary embodiments are implementations of the disclosed devices and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention.

1. An indicating device wherein the effect of one parameter is substantially counter balanced by an effect of another parameter of the device.

2. The indicating device of claim 1 wherein the effect of temperature is substantially counter balanced either by a process taking place within the indicating device or a material within the indicating device.

3. The indicating device of claim 2 wherein the effect of temperature is substantially counter balanced by a process composed of one or more of degradation, polymerization, crosslinking, depolymerization, decomposition, conversion, complexation, halogenation, dehydrohalogenation, precipitation, catalytic reaction, synthesis, displacement, acid-base, oxidation-reduction, neutralization, condensation, isomerization, hydrolysis, addition, elimination, substitution, rearrangement, adsorption-desorption, exchange, redox, gelling, swelling, change in viscosity or hardness, density/specific gravity and solubility.

4. The indicating device of claim 3 wherein the effect of temperature is substantially counter balanced by a process of crosslinking of a medium or binder material of the device.

5. The indicating device of claim 4 wherein an increase in the rate of diffusion due to increase in temperature is substantially counter balanced by crosslinking of a medium or binder material of the device.

6. The indicating device of claim 5 wherein the increase in rate of diffusion due to increase in temperature is substantially counter balanced by crosslinking a barrier layer with a crosslinking agent.

7. The indicating device of claim 6 wherein the crosslinking agent is a polymerizable monomer and multivalent cation.

8. The indicating device of claim 1 which is a time indicating device having substantially no effect of temperature.

9. The time indicating device of claim 8 having an overall activation energy below 10 kcal/mole.

10. The time indicating device of claim 9 having an overall activation energy of near zero kcal/mole.

11. The time indicating device of claim 8 which is color changing or self-reading.

12. The indicating device of claim 1 which is used as visual validation of time, safety sticker, self-timing retail sticker, biological industrial process monitoring, self-expiring stickers to prevent re-use, employee ID and security ID labels, visitors badges, self-expiring parking tags, package and shipping labels, wrist bands, time indicating tickets for trains, buses, sport events and theaters, self-expiring passes for tours, emergency rooms, hospitals, museums, and other locations, event passes, security labels for screened luggage, purses, bags at airports to show the aircraft control people that the particular items were inspected, unmanned but video controlled entrances for visitors where the self-expiring visitor label is issued electronically.

13. The time indicating device of claim 8 which is used as visual validation of time, safety sticker, self-timing retail sticker, biological industrial process monitoring, self-expiring stickers to prevent re-use, employee ID and security ID labels, visitors badges, self-expiring parking tags, package and shipping labels, wrist bands, time indicating tickets for trains, buses, sport events and theaters, self-expiring passes for tours, emergency rooms, hospitals, museums, and other locations, event passes, security labels for screened luggage, purses, bags at airports to show the aircraft control people that the particular items were inspected, unmanned but video controlled entrances for visitors where the self-expiring visitor label is issued electronically.

14. The time indicating device of claim 8 comprising an activator which is capable of crosslinking a medium of the device.

15. The time indicating device of claim 14 comprising an activator which is capable of crosslinking a barrier layer the device.

16. The time indicating device of claim 14 comprising an indicator and an activator which react to produce a color change or change in transparency.

17. The time indicating device of claim 16 comprising a zero-valent metal as an indicator layer, phosphoric acid as an activator and polyvinyl pyrrolidone as a barrier layer of the device.

18. The time indicating device of claim 17 wherein the zero-valent metal is aluminum.

19. The time indicating device of claim 16 comprising a pH dye as an indicator layer, phosphoric acid as an activator and polyvinyl pyrrolidone as a barrier layer of the device.

20. The time indicating device of claim 19 wherein the pH dye is pentamethoxy triphenyl methanol.

21. The time-indicating device of claim 8 wherein the activation energy, service life or shelf life of the system is varied or adjusted by changing one or more of the parameters selected from the group of: nature and thickness of activator, indicator and barrier layers and nature and quantity of activator, indicators and additives.

22. The time-indicating device of claim 21 wherein the activator is a crosslinking agent.

23. The time indicating device of claim 8 which further comprises: a) an indicator tape affixed to a first substrate wherein said indicator tape comprises said indicator layer; and b) an activator tape affixed to a second substrate wherein said second substrate having thereon said activator layer composed of a matrix layer containing said activator or the precursor of the activator wherein said indicator tape and said activator tape are bonded together with at least one adhesive.

24. The time indicating device of claim 23 wherein the activator has capability of crosslinking a matrix or a barrier layer of the device.

25. The time indicating device of claim 24 wherein the indicator tape and the activator tape comprise a sealing tape.

26. The time indicating device of claim 8 having an indicator layer and an activator layer wherein a time required for a change in the indicator layer or an activation energy of the system is varied or adjusted by changing one or more of the parameters selected from the group consisting of nature and thickness of the activator, indicator and barrier layers and nature and quantity of activator, indicator and additives.

27. The time indicating device of claim 26 wherein the additive is a crosslinking agent.

28. A method for obtaining an indicating device wherein the effect of one parameter is substantially counter balanced by an effect of another parameter of the device which comprises choosing an activator and barrier combination which is capable of a process which is independent of temperature and is of one or more of group consisting of degradation, crosslinking, polymerization, depolymerization, decomposition, conversion, complexation, halogenation, dehydrohalogenation, precipitation, catalytic reaction, synthesis, displacement, acid-base, oxidation-reduction, neutralization, condensation, isomerization, hydrolysis, addition, elimination, substitution, rearrangement, adsorption-desorption, exchange, redox, gelling, swelling, change in viscosity or hardness, density/specific gravity and solubility.

29. The method of claim 28 which is polymerization or crosslinking.
